(19) United States
(12) Patent Application Publication
(10) Pub. No.: US 2022/0135080 A1
(43) Pub. Date: May 5, 2022

(54) VEHICLE CONTROL SYSTEM AND VEHICLE CONTROL DEVICE

(71) Applicant: Mitsubishi Electric Corporation, Tokyo (JP)

(72) Inventors: Tetsuharu HAMADA, Tokyo (JP); Akinobu SUGIYAMA, Tokyo (JP); Kazunori TAKAHASHI, Tokyo (JP)

(73) Assignee: Mitsubishi Electric Corporation, Tokyo (JP)

(21) Appl. No.: 17/394,600

(22) Filed: Aug. 5, 2021

(30) Foreign Application Priority Data
Nov. 5, 2020 (JP) 2020-184879

(51) Int. Cl. B60W 60/00; B60W 30/06; G07C 5/08; G07C 5/00

(52) U.S. Cl. CPC B60W 60/00186; G07C 5/008; G07C 5/0816; B60W 30/06

(57) ABSTRACT

An object of the present disclosure is to accurately forced stop autonomous vehicle control when a failure occurs in a remote control terminal without mounting an additional sensor on a vehicle. The vehicle control device includes the detection unit that detects a forced stop operation, a control unit that implements the autonomous parking control of the vehicle, and a calculation unit that causes the control unit to perform the autonomous parking control when the start command is received from the remote control terminal, and causes the control unit to stop the autonomous parking control when the stop command is received from the remote control terminal. When the detection unit detects the forced stop operation while the control unit is performing the autonomous parking control, the calculation unit causes the control unit to stop the autonomous parking control even without receiving the stop command from the remote control terminal.

### BACKGROUND OF THE INVENTION

### Field of the Invention

The present disclosure relates to vehicle control.

### Description of the Background Art

A technique for remotely instructing the start or stop of autonomous parking control of a vehicle from outside the vehicle by using a remote control terminal such as a smart key or a smartphone has been put into practical use. In the technique, a function capable of a forced stop of the autonomous parking control without relying on the remote control terminal has been demanded, assuming that a failure occurs in the remote control terminal. Examples of failures in remote control terminals include the sticking of a switching mechanism of the smart key or the inoperability of the smartphone for some reason.

Japanese Patent Application Laid-Open No. 2018-172061 discloses a remote parking system (hereinafter, also referred to as a vehicle control system) including an image sensor, a distance sensor, and a vibration sensor. The vehicle control system of Japanese Patent Application Laid-Open No. 2018-172061 uses an image sensor and a distance sensor to detect that the user has approached the vehicle, and uses a vibration sensor to detect vertical vibration caused by the user hitting the hood of the vehicle. When the vibration sensor detects vertical vibration, the remote parking system of Japanese Patent Application Laid-Open No. 2018-172061 stops the autonomous parking control of the vehicle.

### SUMMARY

In the vehicle control system described in Japanese Patent Application Laid-Open No. 2018-172061, when a failure occurs in the remote control terminal, the user can forcibly stop the autonomous parking control by approaching the vehicle and hitting the hood thereof.

However, the vehicle control system described in Japanese Patent Application Laid-Open No. 2018-172061 has a problem that an additional sensor such as a vibration sensor or a distance sensor is required in addition to a sensor conventionally mounted on a vehicle such as a gyro sensor or an acceleration sensor. Further, the vehicle control system described in Japanese Patent Application Laid-Open No. 2018-172061 also has a problem that the detection accuracy is low due to the user's approach to the vehicle and the vertical vibration of the vehicle by the user have to be detected under the state where the behavior associated with parking is occurring in the vehicle.

The object of the technique of the present disclosure is to accurately forced stop autonomous vehicle control when a failure occurs in a remote control terminal without mounting an additional sensor on a vehicle, in a vehicle control system capable of instructing the autonomous parking control of the vehicle from a remote control terminal.

The vehicle control system of the present disclosure is a vehicle control system including a remote control terminal and a vehicle control device. The vehicle control device receives a start command and a stop command for the autonomous parking control of a vehicle from the remote control terminal by wireless communication with the remote control terminal. The vehicle control device includes a detection unit, a control unit, and a calculation unit 4. The detection unit detects a forced stop operation including at least one of a door-opening operation of the vehicle and an opening/closing operation of a door mirror of the vehicle. The control unit implements the autonomous parking control of the vehicle. The calculation unit causes the control unit to perform the autonomous parking control when the start command is received from the remote control terminal and causes the control unit to stop the autonomous parking control when the stop command is received from the remote control terminal. When the detection unit detects the forced stop operation while the control unit is performing the autonomous parking control, the calculation unit causes the control unit to stop the autonomous parking control even without receiving the stop command from the remote control terminal.

According to the vehicle control system of the present disclosure, an accurate forced stop of autonomous vehicle control is performable when a failure occurs in a remote control terminal without mounting an additional sensor on a vehicle.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a configuration of a vehicle control system according to Embodiment 1;

FIG. 2 is a diagram illustrating a hardware configuration of the vehicle control system according to Embodiment 1;

FIG. 3 is a diagram illustrating a hardware configuration of the vehicle control system according to Embodiment 1;

FIG. 4 is a flowchart illustrating an operation of the vehicle control system according to Embodiment 1;

FIG. 5 is a block diagram illustrating a configuration of a vehicle control system according to Embodiment 2; and

FIG. 6 is a flowchart illustrating an operation of the vehicle control system according to Embodiment 2.

### DESCRIPTION OF THE PREFERRED EMBODIMENTS

Hereinafter, a configuration and an operation of a vehicle control system of the present disclosure will be described with reference to the drawings according to preferred embodiments. In each Embodiment, the same or corresponding components are designated by the same reference numerals, and duplicate description will be omitted as appropriate.

### A. Embodiment 1

<A-1. Configuration>

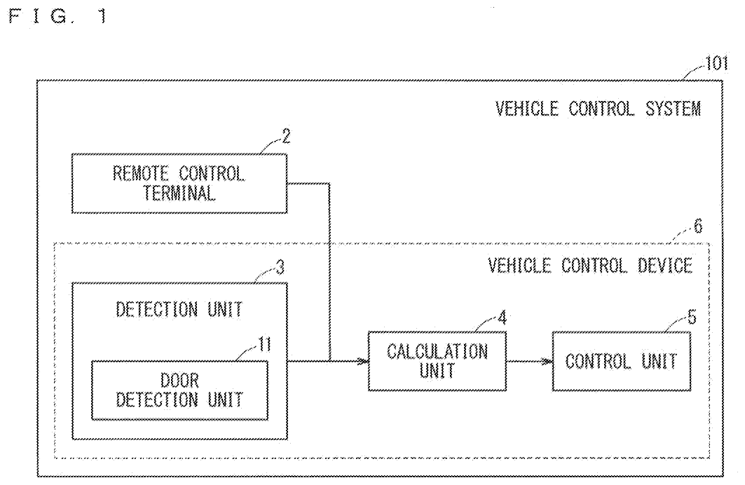

FIG. 1 is a configuration diagram of a vehicle control system 101 according to Embodiment 1. The vehicle control system 101 includes a remote control terminal 2 and a vehicle control device 6. In the following description, the vehicle controlled by the remote control terminal 2 is simply referred to as a “vehicle”.

The remote control terminal 2 is a terminal capable of allowing the user to instruct to start and stop the autonomous parking control of the vehicle from the outside of the vehicle. That is, the remote control terminal 2 receives the user's operation and outputs the start command and the stop command of the autonomous parking control to a calculation unit 4. Any terminal may be adopted as the remote control terminal 2 as long as it realizes these functions, and is typically a smart key or a smartphone having a wireless transmission function.

The vehicle control device 6 includes a detection unit 3, the calculation unit 4, and a control unit 5.

The detection unit 3 includes a door detection unit 11 and outputs the detection result of the door detection unit 11 to the calculation unit 4.

The door detection unit 11 detects that the user performs a door-opening operation of the vehicle without relying on the remote control terminal 2, by using a sensor or the like mounted on the vehicle. The method by which the door detection unit 11 detects the door-opening operation is not particularly limited thereto. When the door adopts a lever type, the door detection unit 11 may detect the opening/closing operation by the lever. When the door adopts a contact type, the door detection unit 11 may detect a person's contact with the door. The sensor used by the door detection unit 11 may be provided with either a physical switch or an electronic switch. Further, regardless of whether the door is actually opened or closed, the door detection unit 11 detects an action of the user touching the door or moving the door lever in an attempt to open the door as a door-opening operation.

The calculation unit 4 receives the start command and the stop command for the autonomous parking control from the remote control terminal 2, and receives the detection result of the door detection unit 11 from the detection unit 3. Then, the calculation unit 4 switches on/off an autonomous parking control mode of the vehicle based on the received information. Specifically, when the door-opening operation of the vehicle is being performed, the calculation unit 4 maintains the autonomous parking control mode of the vehicle off or switches the mode from on to off. Further, when the door-opening operation of the vehicle is not being performed, the calculation unit 4 turns the autonomous parking control mode on in response to the start command of the autonomous parking control from the remote control terminal 2. Here, as a condition for turning on the autonomous parking control mode of the vehicle, the door-opening operation not being performed has been stated. In addition to this, for example, the absence of people in the vehicle, or the absence of obstacles around the vehicle may also be included as the condition.

The remote control terminal 2 may have a function of outputting a door-opening command for the vehicle to the calculation unit 4 in response to the user operation. However, even if the calculation unit 4 receives the door opening command for the vehicle from the remote control terminal 2 while the door-opening operation of the vehicle is not being performed and the autonomous parking control mode is on, the calculation unit 4 maintains the autonomous parking control mode on.

Further, the calculation unit 4 receives the detection result of the door detection unit 11 from the detection unit 3 and processes the data.

The calculation unit 4 issues a control command to the control unit 5 for performing the autonomous parking control when the autonomous parking control mode of the vehicle is on. The control command includes an acceleration command, a deceleration command, and a steering control command of the vehicle. The control unit 5 performs the autonomous parking control by controlling an actuator of the vehicle based on the control command from the calculation unit 4. Here, the power for generating the movement amount of the vehicle is not particularly limited as long as a forward-backward movement amount required for the autonomous parking control can be secured, and such power may include the one by an internal combustion engine, by the electric motor, and the like. Therefore, the acceleration command and the deceleration command may also be commands for controlling the engine speed or torque.

The control unit 5 controls the target steering angle of a steering based on a steering control command from the calculation unit 4. When the steering of the vehicle is an electric power steering, the control unit 5 controls the output of the electric motor of the electric power steering. When the steering of the vehicle is a hydraulic power steering, the control unit 5 controls the output of the hydraulic pump of the hydraulic power steering. The steering device of the vehicle is not limited to the above example, and any one capable of controlling steering may be adopted, for example, a steering device referred to as steering by wire in which the mechanical link between the steering wheel and the wheels is eliminated may be adopted.

Further, the tire angle required for parking need only be controlled, the control unit 5 may control not only the target steering angle of the steering but also the target torque. Further, the tire angle need only be controlled, the control unit 5 is not necessarily required to rotate the steering per se that is actually steered by a person.

In addition, by using an output device mounted on the vehicle, the control unit 5 notifies the outside of the vehicle that the autonomous parking is undergoing. Here, the output device is not particularly limited, and is, for example, hazard lumps, a speaker, a human machine interface (HMI), or the like. ON/OFF of the hazard lumps is performed by, for example, a micro switch or communication. When the HMI is used as the output device, the control unit 5 performs display control of a display, for example. The notification control method by the control unit 5 may be any control method as long as the function is realized, and may be, for example, constant cycle control, non-constant cycle control, or event processing.

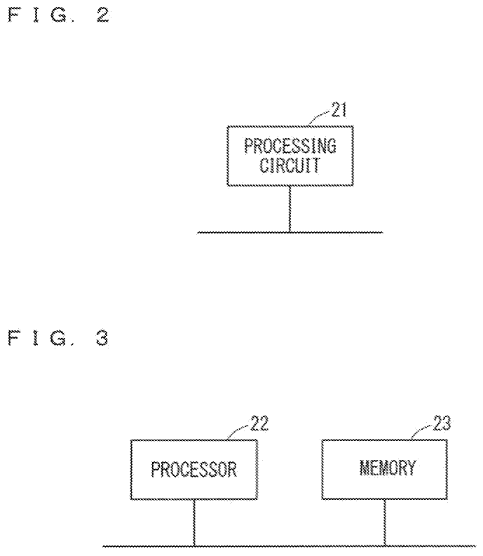

FIG. 2 is a diagram of a hardware configuration of the vehicle control system 101. The function of each component in the vehicle control system 101 is realized by a processing circuit 21 illustrated in FIG. 2. That is, the processing circuit 21 includes the remote control terminal 2, the detection unit 3, the calculation unit 4, and the control unit 5. Dedicated hardware may be applied to the processing circuit 21, or a processor that executes a program stored in a memory may also be applied. The processor is, for example, a central processing unit, a processing unit, an arithmetic unit, a microprocessor, a microcomputer, a Digital Signal Processor (DSP), or the like.

When the dedicated hardware is applied to the processing circuit 21, the processing circuit 21 corresponds to a single circuit, a composite circuit, a programmed processor, a parallel programmed processor, an Application Specific Integrated Circuit (ASIC), or a Field-Programmable Gate Array (FPGA), or the combination thereof. Each of the functions of any unit and the like may be realized by a plurality of processing circuit 21, or may be realized by one processing circuit with each of the functions of the respective units am integrated.

When the processing circuit 21 is a processor, the functions of the detection unit 3 and the like are realized by combination with software or the like (software, firmware, or a combination of software and firmware). The software or the like is described as a program and stored in a memory. As illustrated in FIG. 3, a processor 22 applied to the processing circuit 21 implements the functions of the respective units by reading out and executing the program stored in a memory 23. That is, the vehicle control system 101 includes the memory 23 for storing the program which, eventually, executes a step detecting a forced stop operation including at least one of a door-opening operation of the vehicle and an opening/closing operation of the door mirror, a step of implementing autonomous parking control when a start command is received from the remote control terminal 2, a step of stopping the autonomous parking control when a stop command is received from the remote control terminal 2, when a forced stop operation is detected during the implementation of the autonomous parking control, a step of stopping the autonomous parking control even no stop command from the remote control terminal 2 is received, when executed by the processing circuit 21. In other words, it can be said that the program causes a computer to execute the procedure or method of the detection unit 3 and the like. Here, the memory 23 may be, for example, a non-volatile or volatile semiconductor memory, such as a random access memory (RAM), a read only memory (ROM), a flash memory, an erasable programmable read only memory (EPROM), an electrically erasable programmable read only memory (EEPROM), or the like, a hard disk drive (HDD), a magnetic disk, a flexible disk, an optical disk, a compact disk, a mini disk, a digital versatile disk (DVD) and a drive device therefor, or any storage medium used in the future.

The configuration in which each function of the detection unit 3 and the like is realized by either hardware or software or the like has been described above. However, the present invention is not limited thereto, and a configuration in which part of the vehicle control system 101 is realized by dedicated hardware and another part is realized by software or the like may also be adoptable. For example, for some parts, the functions are realized by the processing circuit 21 as dedicated hardware, and for other parts, the functions are realized by the processing circuit 21 as the processor 22 reading and executing the program stored in the memory 23.

As described above, the vehicle control system 101 can realize the functions described above by hardware, software, or the like, or a combination thereof.

<A-2. Operation>

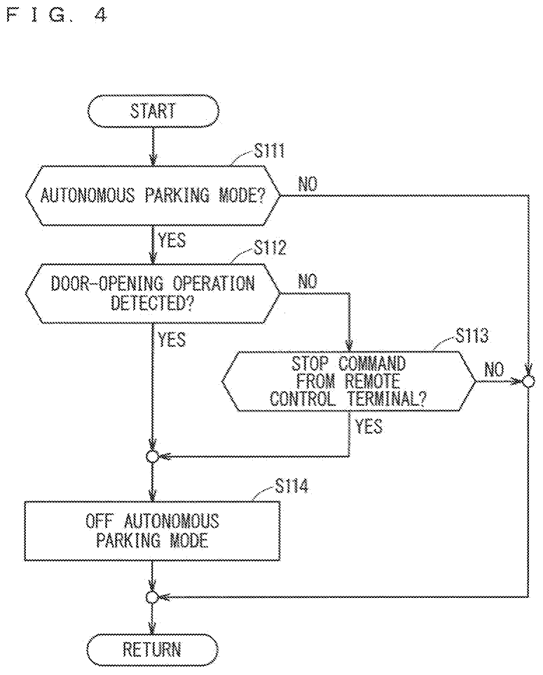

FIG. 4 is a flowchart illustrating a process of turning off the autonomous parking mode of the vehicle by the vehicle control system 101. When the autonomous parking mode of the vehicle is on, the control unit 5 performs the autonomous parking control of the vehicle. The method of autonomous parking control of the vehicle by the control unit 5 is not particularly limited; therefore, the flow of the autonomous parking control is omitted in FIG. 4.

The flow in FIG. 4 is repeatedly executed triggered by the occurrence of a constant cycle, a non-constant cycle, or some event. First, the calculation unit 4 determines whether or not the vehicle is in the autonomous parking mode in a current control cycle (Step S111). When the vehicle is not in the autonomous parking mode in Step S111, the vehicle control system 101 ends the process without performing any action.

When the vehicle is in the autonomous parking mode in Step S111, based on the information from the detection unit 3, the calculation unit 4 determines whether or not the door-opening operation of the vehicle has been performed (Step S112). The detection unit 3 detects the door-opening operation of the vehicle using a sensor or the like mounted on the vehicle and outputs the result to the calculation unit 4. The method of detecting the door-opening operation by the detection unit 3 is not particularly limited. When the door adopts a lever type, the detection unit 3 may detect the opening operation by the lever. When the door adopts a contact type, the detection unit 3 may detect a person's contact with the door. The sensor used by the detection unit 3 may be either a physical switch or an electronic switch.

When the calculation unit 4 determines that the door-opening operation is being performed in Step S112, the calculation unit 4 turns off the autonomous parking mode of the vehicle (Step S114), and causes the control unit 5 to stop the autonomous parking control.

When the calculation unit 4 determines in Step S112 that the door-opening operation is not being performed, it can be considered that no failures nor sticking of the switch in the remote control terminal 2 has occurred and the remote control terminal 2 functions normally. Therefore, the calculation unit 4 determines whether or not the stop command for the autonomous parking control has been received from the remote control terminal 2 (Step S113).

When the calculation unit 4 determines in Step S113 that the stop command for the autonomous parking control has not been received from the remote control terminal 2, the calculation unit 4 ends the process with the autonomous parking mode left turned on.

When the calculation unit 4 determines that the stop command for the autonomous parking control is received from the remote control terminal 2 in Step S113, the calculation unit 4 turns off the autonomous parking mode (Step S114), causes the control unit 5 to stop the autonomous parking control, and ends the process. In this manner, the user can stop the autonomous parking control at an arbitrary timing by operating the remote control terminal 2 to transmit the stop command from the remote control terminal 2 to the vehicle control system 101.

In the flow illustrated in FIG. 4, the order of Step S112 and Step S113 is not allowed to be replaced. This is because if Step S113 is executed before Step S112, the calculation unit 4 cannot shift to a door-opening detection process when a failure such as sticking of the switch occurs after the remote control terminal 2 sends the stop command to the vehicle control system 101, leading to the failure in stopping of the autonomous parking control.

### B. Embodiment 2

<B-1. Configuration>

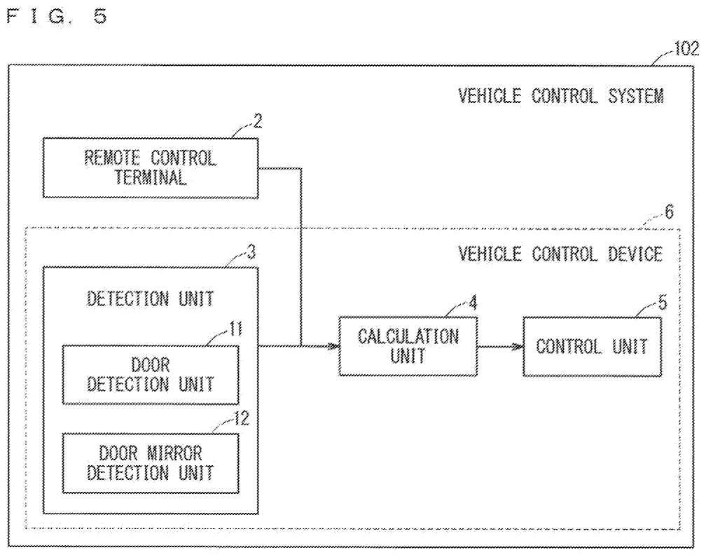

FIG. 5 is a block diagram illustrating a configuration a vehicle control system 102 according to Embodiment 2. The vehicle control system 102 includes a door mirror detection unit 12 in addition to a door detection unit 11 in a detection unit 3, and the rest of its configuration is the same as the vehicle control system 101 of Embodiment 1. However, the vehicle control system 102 does not necessarily include the door detection unit 11.

The door mirror detection unit 12 detects the opening/closing operation of the door mirror of the vehicle; therefore the door mirror detection unit 12 includes at least one of a rotation angle detection function that detects the relative rotation angle or the absolute rotation angle around the opening/closing axis of the door mirror, a displacement measurement function that measures the displacement between the vehicle body and the door mirror, and a surrounding environment imaging function that captures the surrounding environment of the door mirror. Specifically, the rotation angle detection function is realized by a rotary encoder or a limit switch. The displacement measurement function is realized by a sensor that measures the displacement between the vehicle body and the door mirror. The surrounding environment imaging function is specifically realized by a CCD camera. The CCD camera is mounted on the door mirror or the vehicle body. When the CCD camera is mounted on the vehicle body, the imaging range includes the door mirror.

The calculation unit 4 acquires the detection result of the door detection unit 11 and the detection result of the door mirror detection unit 12 from the detection unit 3.

<B-2. Operation>

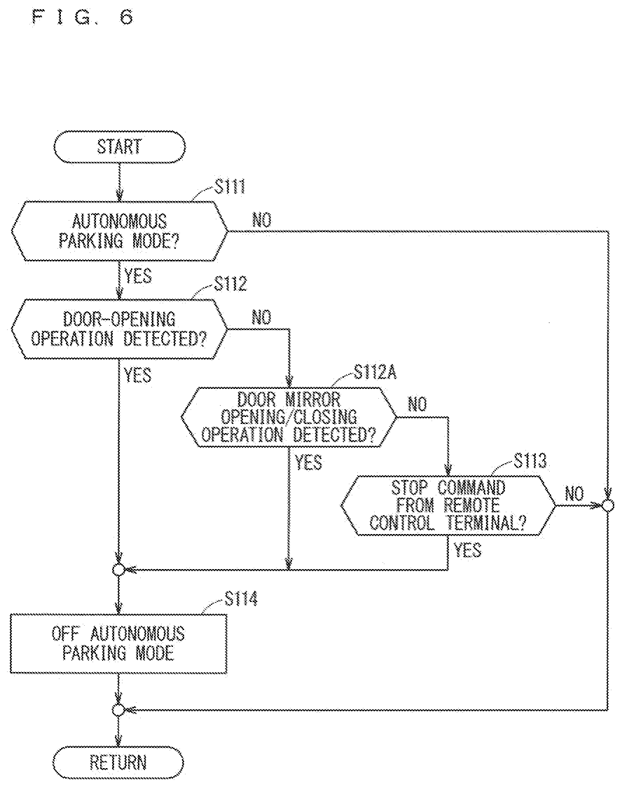

FIG. 6 is a flowchart illustrating a process of turning off the autonomous parking mode of the vehicle by the vehicle control system 101. The flowchart of FIG. 6 is obtained by adding Step S112A between Steps S112 and S113 with respect to the flowchart of the vehicle control system 102 of Embodiment 1 illustrated in FIG. 4. Therefore, the operation of the vehicle control system 102 different from that of Embodiment 1 will be described below.

When it is determined that the door-opening operation is not being performed in Step S112, the calculation unit 4 determines whether or not the opening/closing operation of the door mirror is being performed based on the detection result of the door mirror detection unit 12 (Step S112A). Here, the door mirror detection unit 12 detects the opening/closing operation of the door mirror when the door mirror changes from the folded state to the opened state or changes from the opened state to the folded state.

When the rotary encoder is used for the door mirror detection unit 12, the door mirror detection unit 12 detects the opening/closing operation of the door mirror when the relative rotation angle around the opening/closing axis of the door mirror becomes equal to or greater than a predetermined threshold value.

When the limit switch is used for the door mirror detection unit 12, the limit switch is set so that the contact is turned on or off when the door mirror is moved to a predetermined position. The door mirror detection unit 12 detects the opening/closing operation of the door mirror when the contact of the limit switch is turned on or off.

When the displacement sensor is used for the door mirror detection unit 12, the door mirror detection unit 12 detects the opening/closing operation of the door mirror from the change in the relative position between the vehicle body and the door mirror.

When a surrounding monitoring camera is used for the door mirror detection unit 12, the image captured by the surrounding monitoring camera changes significantly as the door mirror opens and closes. Therefore, the door mirror detection unit 12 detects the opening/closing operation of the door mirror when the captured image of the surrounding monitoring camera changes equal to or greater than a predetermined threshold value or when the rate of change of the captured image exceeds the threshold value.

When the calculation unit 4 determines that the opening/closing operation of the door mirror is not being performed in Step S112A, the calculation unit 4 proceeds to the process of Step S113. That is, in Embodiment 2, when the door-opening operation is not performed (No in Step S112) and the opening/closing operation of the door mirror is not performed (No in Step S112A), it is assumed that the remote control terminal 2 is functioning normally without a failure or sticking of the switch. Therefore, the calculation unit 4 determines whether or not the stop command for the autonomous parking control has been received from the remote control terminal 2 (Step S113).

In the flowchart of FIG. 6, the order of Step S112 and Step S112A may be replaced. However, Step S113 needs to be performed after Step S112 and Step S112A. This is because if Step S113 is executed before Step S112 and Step S112A, the calculation unit 4 cannot shift to a door-opening detection process or a door mirror opening/closing detection process when a failure such as sticking of the switch occurs after the remote control terminal 2 sends the stop command to the vehicle control system 102, leading to the failure in stopping of the autonomous parking control. Other processes may be performed between each step as long as the above order is maintained.

### C. Effects

The vehicle control systems 101 and 102 described above include the remote control terminal 2 and the vehicle control device 6 that receive a start command and a stop command for the autonomous parking control of a vehicle from the remote control terminal 2 by wireless communication with the remote control terminal 2. The vehicle control device 6 includes the detection unit 3 that detects a forced stop operation including at least one of the door-opening operation of the vehicle and the opening/closing operation of the door mirror, a control unit 5 that implements the autonomous parking control of the vehicle, and a calculation unit 4 that causes the control unit 5 to perform the autonomous parking control when the start command is received from the remote control terminal 2, and causes the control unit 5 to stop the autonomous parking control when the stop command is received from the remote control terminal 2. When the detection unit 3 detects the forced stop operation while the control unit 5 is performing the autonomous parking control, the calculation unit 4 causes the control unit 5 to stop the autonomous parking control even without receiving the stop command from the remote control terminal 2. Therefore, according to the vehicle control systems 101 and 102, even when a failure occurs in the remote control terminal 2 and the stop command for the autonomous parking control cannot be transmitted from the remote control terminal 2 to the vehicle control systems 101 and 102, a forced stop of the autonomous parking control is implemented by the user performing at least one of the door-opening operation of the vehicle and the opening/closing operation of the door mirror. The door-opening operation of the vehicle or the opening/closing operation of the door mirror is detectable without an additional sensor such as a vibration sensor or a distance sensor. Further, highly accurate detection is performable with the door-opening operation or the opening/closing operation of the door mirror compared with the approach of the user and the vertical vibration of the vehicle by the user.

It should be noted that Embodiments can be arbitrarily combined and can be appropriately modified or omitted.

While the invention has been shown and described in detail, the foregoing description is in all aspects illustrative and not restrictive. It is therefore understood that numerous modifications and variations can be devised without departing from the scope of the invention.

What is claimed is:

1. A vehicle control system including a remote control terminal and a vehicle control device configured to receive a start command and a stop command for autonomous parking control of a vehicle from the remote control terminal by wireless communication with the remote control terminal, the vehicle control device comprising:
a processor to execute a program; and
a memory to store the program which, which executed by the processor, performs processes of,
detecting a forced stop operation including at least one of a door-opening operation of the vehicle and an opening/closing operation of a door mirror of the vehicle,
performing the autonomous parking control when the start command is received from the remote control terminal and stopping the autonomous parking control when the stop command is received from the remote control terminal, and,
when the forced stop operation is detected during the autonomous parking control, stopping the autonomous parking control even when the stop command is not received from the remote control terminal.

2. The vehicle control system according to claim 1, wherein
the forced stop operation includes the door-opening operation of the vehicle, and
regardless of whether the door is actually opened, an action of a user attempting to open the door is detected as the door-opening operation.

3. The vehicle control system according to claim 2, wherein
the opening/closing operation of the door mirror of the vehicle is detected based on a change in a rotation angle of the door mirror.

4. The vehicle control system according to claim 2, wherein
the opening/closing operation of the door mirror of the vehicle is detected based on a change in a relative position between the door mirror and a vehicle body of the vehicle.

5. The vehicle control system according to claim 2, further comprising
a camera attached to the door mirror or the vehicle body of the vehicle, wherein
the opening/closing operation of the door mirror of the vehicle is detected based on a change in an image captured by the camera.

6. A vehicle control device comprising:
a processor to execute a program; and
a memory to store the program which, which executed by the processor, performs processes of,
detecting a forced stop operation including at least one of a door-opening operation of a vehicle and an opening/closing operation of a door mirror of the vehicle,
by wireless communication with a remote control terminal, receiving a start command and a stop command for autonomous parking control of the vehicle from the remote control terminal, performing the autonomous parking control when the start command is received, and stopping the autonomous parking control when the stop command is received, and,
when the forced stop operation is detected during the autonomous parking control, stopping the autonomous parking control even when the stop command is not received from the remote control terminal.
